(19) United States
(12) Patent Application Publication
(10) Pub. No.: US 2008/0027958 A1
(43) Pub. Date: Jan. 31, 2008

(54) Data Cleansing for a Data Warehouse

(75) Inventors: Rahul Kapoor, Bellevue, WA (US); Yi Mao, Redmond, WA (US); LiHui Xu, Bellevue, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/461,370

(22) Filed: Jul. 31, 2006

(51) Int. Cl. G06F 17/00

(52) U.S. Cl. 707/101

(57) ABSTRACT

This document describes tools capable of modifying data records without human interaction, modifying data records responsive to analysis from various types of data-quality modules, and/or reversing modifications. These tools may also enable a data-quality module to find errors by analyzing fewer than all of the records as effectively as if the data-quality module analyzed all of the records.

### BACKGROUND

Data records often contain errors. Two records may refer to one particular item in two different ways, for instance. Or two records may look different, but actually refer to one item. These errors can cause problems for people relying on these records. Assume that a company wants to send catalogs to all of its prior customers and that it has two records for the same prior customer, e.g., “Jane Doe, 123 W. American St., 90005” and “Jane T. doe, West 123 American Street, 90005”. If the company does not know that these two records refer to one prior customer, not two, it may send Jane Doe two catalogs.

Many current techniques for correcting data, often called “data cleansing”, are slow and expensive. Some techniques are slow because they rely on human interaction. Other techniques are computationally expensive because they require all related data records in a data warehouse to be analyzed as one group.

For example, some data-cleansing techniques are performed as part of an Extract, Transform, and Load (ETL) process where data from databases may be extracted from the databases, transformed into a format acceptable to a data warehouse, and stored in the data warehouse. These techniques may be slow and expensive because they may use software applications to find errors but rely on humans to manually fix them, use computational resources at peak times (e.g., at regular extraction periods during hours of high computational need), not be well suited to the cleansing needed for the type of data, or leave errors in the data warehouse that may later require analysis of all related data records in the data warehouse as one group.

### SUMMARY

This document describes tools capable of modifying data records without human interaction, modifying data records responsive to analysis from various types of data-quality modules, and/or reversing modifications. These tools may also enable a data-quality module to find errors by analyzing fewer than all of the records as effectively as if the data-quality module analyzed all of the records.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “tools,” for instance, may refer to system(s), method(s), computer-readable instructions, and/or technique(s) as permitted by the context above and throughout the document.

### BRIEF DESCRIPTION OF THE DRAWINGS

FIG. 1 illustrates an exemplary operating environment in which various embodiments of the tools may operate.

FIG. 2 illustrates an exemplary cleansing application acting in conjunction with a deduping data-quality module to clean data records and perform other actions.

FIG. 3 continues the illustration of FIG. 2 after receipt of additional data records.

FIG. 4 continues the illustration of FIG. 3 showing exemplary cleaning of a set of new clean data and a set of old clean data effective to clean all of the data records recorded in the data warehouse.

FIG. 5 continues the illustration of FIG. 4 responsive to receiving an indication to delete a data record.

FIG. 6 continues the illustration of FIG. 4 responsive to receiving a selection to reverse modifications made to the data records.

FIG. 7 is an exemplary process illustrating some ways in which the tools may act to modify data records without human interaction, modify data records responsive to analysis from various types of data-quality modules, and/or reverse modifications, as well as other actions.

The same numbers are used throughout the disclosure and figures to reference like components and features.

### DETAILED DESCRIPTION

### Overview

The following document describes tools capable of modifying data records without human interaction to improve data quality in the records, modifying data records responsive to analysis from various types of data-quality modules, and/or reversing modifications. The tools may do so outside of an Extract, Transform, and Load (ETL) process, thereby potentially enabling quicker and simpler ETLs and allocation of cleansing processes to times of lower processing demands. The tools may also incrementally modify data records in a data warehouse, such as responsive to incremental data-record loading from periodic ETLs. Also, when data records in a data warehouse are part of two sets—each of which is clean compared to other records in the set but not to records of the other set—the tools may enable a data-quality module to find errors by analyzing fewer than all of the records in both sets as effectively as if the data-quality module analyzed all of the records.

An environment in which the tools may enable these and other actions is set forth below in a section entitled Exemplary Operating Environment. This section is followed by another section describing one exemplary way in which the tools may act in conjunction with a deduping data-quality module and is entitled Deduping Example. A final section describes various other embodiments and manners in which the tools may act, such as in conjunction with other data-quality modules, and is entitled Other Embodiments of the Tools. This overview, including these section titles and summaries, is provided for the reader's convenience and is not intended to limit the scope of the claims or the entitled sections.

### Exemplary Operating Environment

Before describing the tools in detail, the following discussion of an exemplary operating environment is provided to assist the reader in understanding some ways in which various inventive aspects of the tools may be employed. The environment described below constitutes but one example and is not intended to limit application of the tools to any one particular operating environment. Other environments may be used without departing from the spirit and scope of the claimed subject matter.

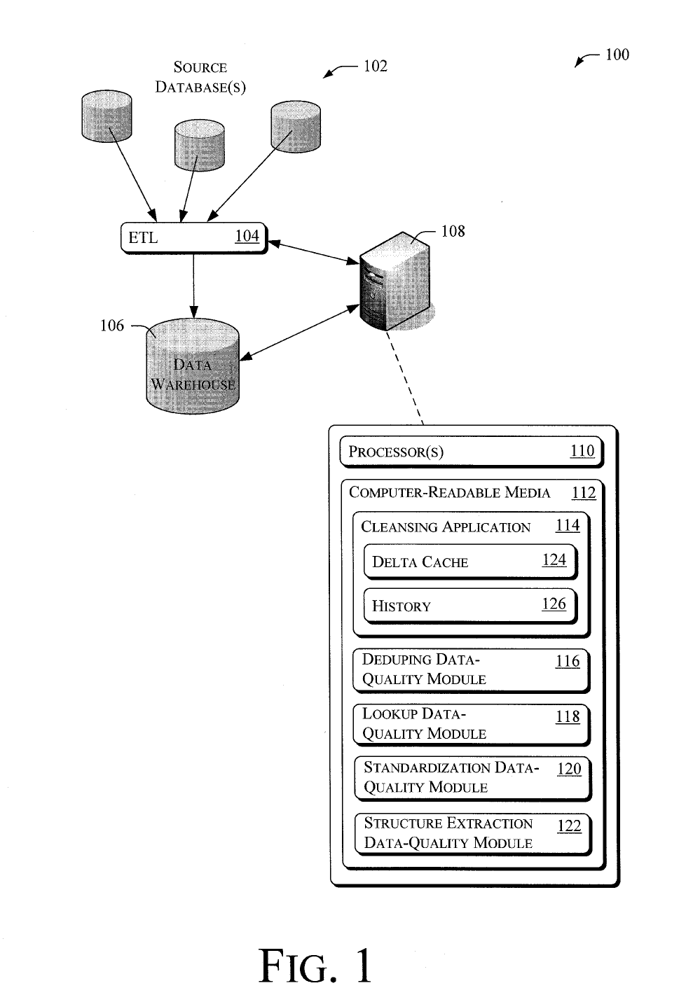

FIG. 1 illustrates one such operating environment generally at 100 having source databases 102, an ETL entity 104 (e.g., a computing device having processor(s) and an appropriate application capable of executing an ETL package), a data warehouse 106, and a computing device 108. Communications between these entities are shown with arrows. The ETL entity may, for example, extract data from the source databases, transform it into a format acceptable to the data warehouse, and load data records of the appropriate format into the data warehouse. The computing device interacts with at least the data warehouse but may also interact with the ETL entity as described elsewhere herein.

The computing device comprises one or more processor(s) 110 and computer-readable media 112. The computing device is shown with a server icon, though it may comprise one or multiple computing devices of various types. The processors are capable of accessing and/or executing the computer-readable media. The computer-readable media comprises or has access to a cleansing application 114, a deduping data-quality module 116, a lookup data-quality module 118, a standardization data-quality module 120, and a structure extraction data-quality module 122. Each of the data-quality modules is capable of making data-quality recommendations to improve the quality of the data records (e.g., find errors), such as those based on similarities between data records.

The cleansing application is capable of interacting with arbitrary numbers or types of data-quality modules. In some cases the cleansing application is a computer application platform enabling a user to plug-and-play data-quality modules, such as any of those listed. The user may do so, also in some cases, without needing to alter or otherwise customize the cleansing application or the data-cleansing modules. Thus, a user may plug-and-play one, two, or many cleansing modules even of different types, brands, and having different interface mechanisms and/or protocols. This enables users to select whichever types or brands of data-quality module suits their needs, budget, or type of data they want cleaned.

The cleansing application comprises or has access to a delta cache 124 and a history 126. The cleansing application keeps track of which data records in the data warehouse are new, old, and/or clean in the delta cache, as well as other information. The cleansing application also maintains a history, which records interactions with the data warehouse and/or the data records, such as which record was marked as a duplicate of another, which contains an error, which has been deleted, when data records are modified or stored, and so forth. The history provides sufficient information for a third party to audit the data warehouse and modifications to the data records. In some cases, the history also enables reversal of modifications to data records in the data warehouse, either automatically or manually. The delta cache and history are shown integral with the cleansing application but may also be separate, e.g., stored in the data warehouse.

### Deduping Example

This section describes one particular example where cleansing application 114 acts in conjunction with deduping data-quality module 116 (the “deduping module”) to clean data records and perform other actions. This example is an implementation of the tools but is not intended to limit the scope of the tools or the claimed embodiments.

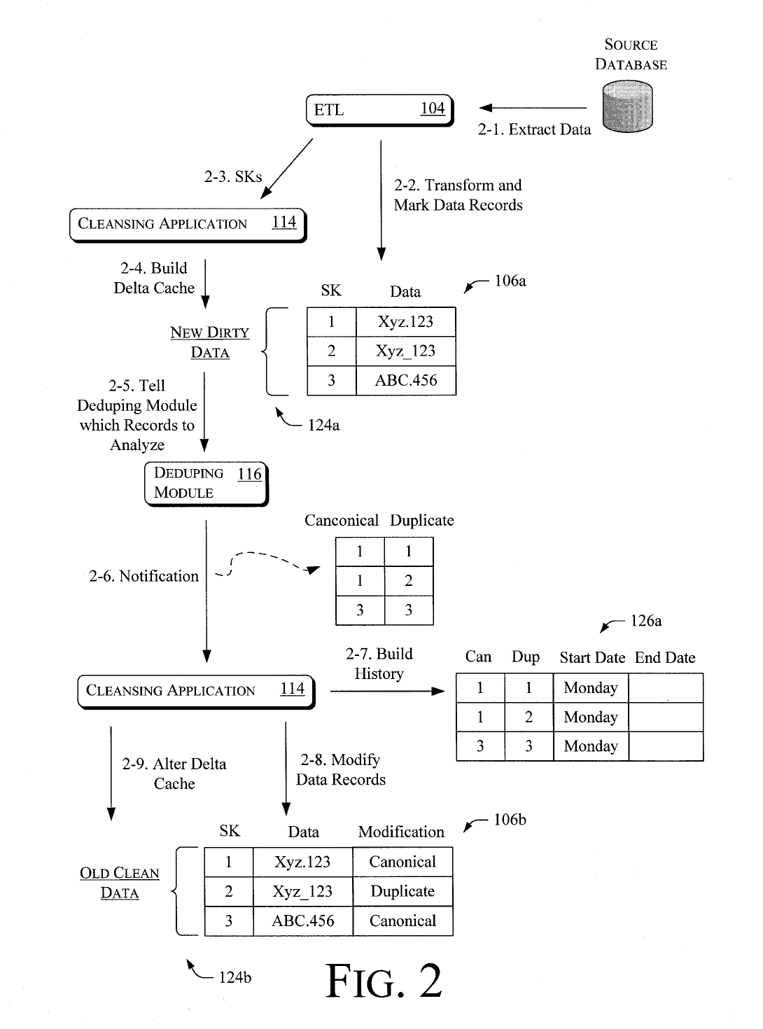

This example is illustrated in FIGS. 2 through 6 and shows actions and results of the cleansing application acting in conjunction with the deduping module for cleaning data records loaded incrementally by the ETL entity. The example assumes that a user previously selected the deduping module to identify errors, rather than other or additional data-quality modules. The example starts with the data warehouse empty.

At arrow 2-1 in FIG. 2, the ETL entity extracts data from a source database. At arrow 2-2 the ETL entity transforms the data into data records in a format acceptable to the data warehouse and loads the data into the data warehouse, which is illustrated at 106a. Also at arrow 2-2, the ETL entity marks each record with a unique increasing integer (e.g., a surrogate key (SK)). At arrow 2-3 the ETL entity sends this unique identifying information (SKs) to the cleansing application.

At arrow 2-4 the cleansing application uses this information to determine which data records are new, old, and/or dirty and builds this into delta cache 124a, such as by deeming data records that have a higher-numbered SK newer than ones with lower-numbered SKs previously added to the delta cache. Here the cleansing application notes which data records are new and as-yet-uncleaned (“dirty”) in the delta cache, and stores this in the data warehouse. This is illustrated by the text “New Dirty Data” in FIG. 2. In this example, all of the records in the data warehouse are new and dirty as none have been cleaned and no old records exist.

At arrow 2-5, the cleansing application tells the deduping module which records to analyze. This example shows a very simple case having three data records two of which are likely duplicates, though in practice an ETL entity may load thousands or even many millions of records many of which will not be duplicates. In telling the deduping module, the cleansing application indicates which of the records in the data warehouse are new and dirty based on the delta cache as illustrated at 124a, here records having SKs of 1, 2, and 3. The cleansing application does not need to know what kind of analysis is being performed by a data-quality module, though here the analysis is intended to find duplicate records.

At arrow 2-6 the deduping module notifies the cleansing application that the record marked SK=1 is a canonical record (the best record of one or more duplicate records) and that the record marked SK=2 is a duplicate. It also notes that SK=3 is a canonical record because it is the only record of its type.

At arrow 2-7 the cleansing application builds a history of actions that have or will be performed on the data warehouse. Here the cleansing application builds into the history, illustrated at 126a, the recommendation from the deduping module, which the cleansing application will use to modify the data records in the data warehouse, and the date that the data records are modified (the “Start Date”).

At arrow 2-8 the cleansing application automatically modifies the data records in the data warehouse effective to clean them. The cleansing application does not need any user interaction or manual entry of modifications to clean the data records. Here the cleansing application notes which records are canonical and which are duplicates by sending a command to the data warehouse to make this modification, the result of which is illustrated at 106b. This modification is sufficient for other applications that later use information from the data warehouse to know how best to handle record 2 (the record marked with SK=2).

Continuing the example from the Background, a company can know not to send two catalogs to a single customer because it now knows that one record is a duplicate. Some other application using this data likely will use this information to treat “Xyz_{—}123” as the same as “Xyz.123”, which may mean different things to different applications (e.g., that two “Xyz.123”s have been sold, rather than one “Xyz.123” and one “Xyz_{—}123”).

At arrow 2-9 the cleansing application alters the delta cache 124a to reflect this change, thereby marking these records as “Old Clean Data,” which is illustrated at 124b. These data records are clean relative to each other and all other records in the data warehouse (because there are no other records). If they are clean relative to each other but not to other data records, the cleansing application may indicate instead that they are “New Clean Data”, thereby reflecting that they are clean relative to each other but not yet clean relative to other, older records in the data warehouse.

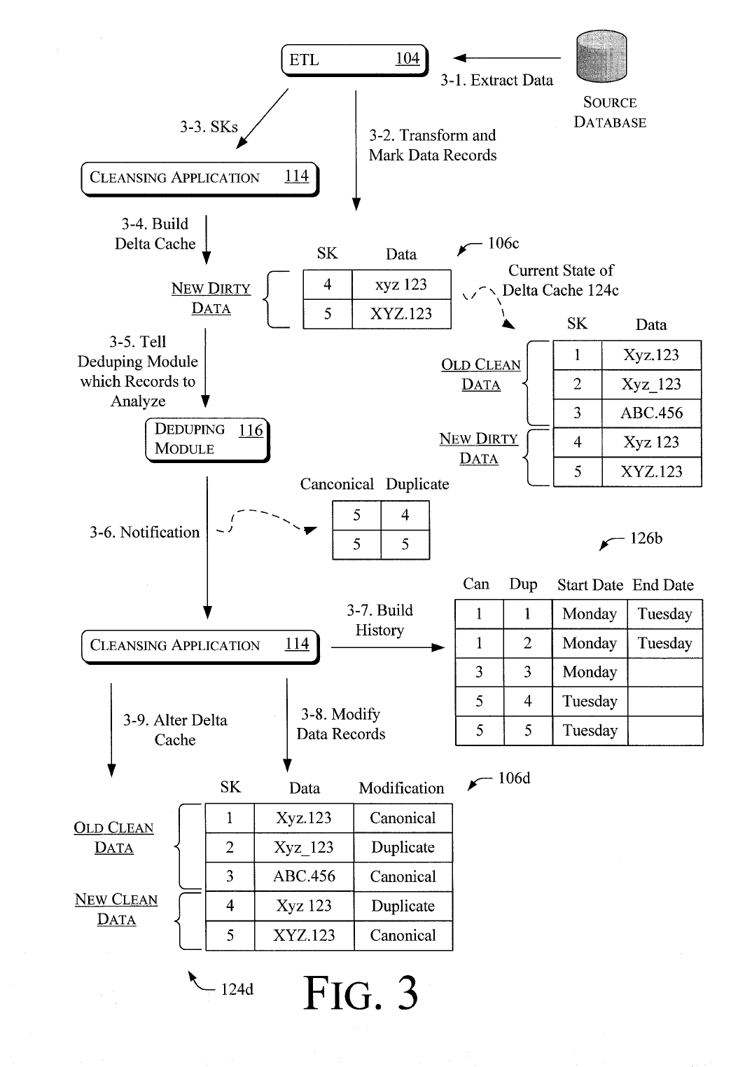

Similarly to FIG. 2, at arrows 3-1 and 3-2 in FIG. 3, the ETL entity extracts additional data from a source database, transforms it, loads it into the data warehouse, and marks each record with a surrogate key (SK). The current state of the data warehouse is illustrated at 106c. At arrow 3-3 the ETL entity sends the SKs to the cleansing application.

At arrow 3-4 the cleansing application uses this information to determine which data records are new, old, and/or dirty and adds this to the delta cache, the result of which is illustrated at 124c. The current state of delta cache 124c is shown next to the change made, here with old clean data cleaned previously (illustrated in FIG. 2) and new dirty data just loaded from the source database.

At arrow 3-5, the cleansing application tells the deduping module which records to analyze. Again this example shows a very simple case for ease in explanation. In telling the deduping module, the cleansing application indicates which of the records in the data warehouse are new and dirty based on the delta cache, here records having SKs of 4 and 5.

At arrow 3-6 the deduping module notifies the cleansing application that the record with SK=5 is a canonical record (the best record of the set being analyzed) and that record SK=4 is its duplicate.

At arrow 3-7 the cleansing application builds a history of actions that have or will be performed on the data warehouse, similarly to as performed at arrow 2-7. The cleansing application also records an end date for actions, here that the modifications made on Monday to records 1, 2, and 3 are potentially replaced by modifications made Tuesday or later. This history 126b also indicates that the old records, while clean relative to each other, are not clean relative to records added Tuesday or later. This example uses days for dates, though other, more specific times may be used (e.g., 12:07.13 am, Oct. 4^{th}, 2005).

At arrow 3-8 the cleansing application automatically modifies the newly added data records in the data warehouse effective to clean them, similarly to as performed at arrow 2-8, which is illustrated at 106d. Note that now the old clean data and the new clean data are each internally clean (clean relative to records within their respective sets) but are not clean relative to records of the other set. Thus, all of the records have two canonicals (SK-1 and 5) for data records that are likely duplicates.

At arrow 3-9, the cleansing application updates the delta cache, the current state of which is illustrated at 124d.

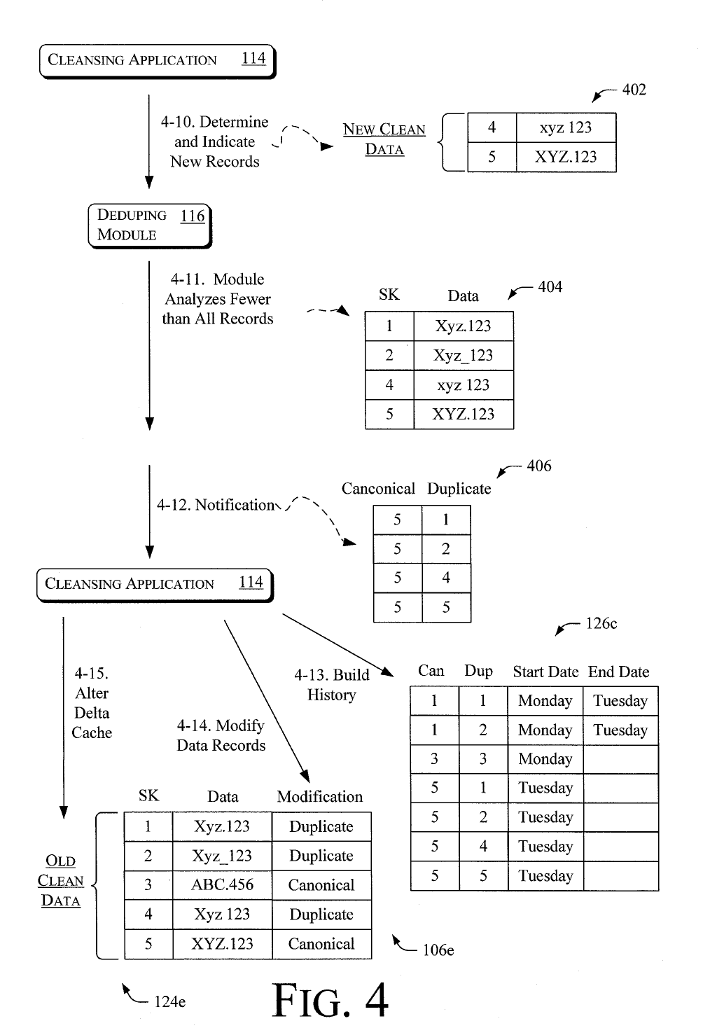

The cleansing application addresses this possible problem as illustrated in FIG. 4. Here the cleansing application enables the deduping module to analyze fewer than all of the records as well as if it analyzed all of them.

At arrow 4-10, the cleansing application determines which records are new and indicates this to the deduping module. The new clean data is noted as records 4 and 5 and illustrated at 402. In response, the deduping module may analyze fewer than all of the records. By knowing which data records are new (e.g., 4 and 5 of records 1-5), the deduping module is potentially enabled to reduce how many records it analyzes.

For example, assume that the illustrated records 1-5 are actually records 1001, 1002, 1003, 1004, and 1005, respectively, of 1,005 total records, and that the deduping module may sort the records by their nearest (most likely to be duplicate) neighbors. The deduping module may then analyze a window around these records rather than all 1,005 of them. Thus, the deduping module may analyze the records, for example, within 20 records plus or minus of each of the new records (1004 and 1005). Assume that records 1004 and 1005 are sorted in the same window along with record 1001 and 1002. By analyzing this window, rather than all of the records 0001 to 1,005, the deduping module may find all of the errors (duplicate records) that it would have found by analyzing all 1,005 records. This may save a significant amount of time and processing power. The other records of the 1,005 may amount to a very large percentage of the records and yet the cleansing application enables the deduping module to analyze only very few of them.

Here for simplicity we assume that the deduping module sorted the records such that only records 1, 2, 4, and 5 are analyzed together. We assume that record 3 was not sorted into proximity to new records 4 and 5 because the text of record 3 is much different that the text of records 4 and 5.

Note, however, that in many cases deduping involves similarity functions that are transitive. In these cases even fewer records are analyzed together, such as just the canonicals of new data records. Here the only canonical for the new records is record 5, thereby permitting analysis of only records 1, 2, and 5 together, as record 4 is considered a duplicate of record 5.

At arrow 4-11, then the deduping module analyzes just records 1, 2, 4, and 5 (illustrated at 404). At arrow 4-12, the deduping module notifies the cleansing application of duplicates. Here the module notifies the cleansing application that the canonical record is record 5 and that records 1, 2, and 4 are duplicates, which is illustrated at 406.

Similarly to arrows 2-7 and 3-7, 2-8 and 3-8, and 2-9 and 3-9, the cleansing application builds history 126c at arrow 4-13, automatically modifies the data records at arrow 4-14 resulting in 106e, and alters the delta cache at arrows 4-15 resulting in 124e, respectively. Note that history 126c indicates that record 5 is the canonical record for records 4, 2, and 1 as of Tuesday. Note also that all of the records 1-5 are old clean data; all of them are clean amongst themselves. This was determined without the deduping module having to analyze record 3 against records 1, 2, 4, and 5. The cleansing application may repeat the process of FIGS. 3 and 4 indefinitely, such as for incremental data loadings.

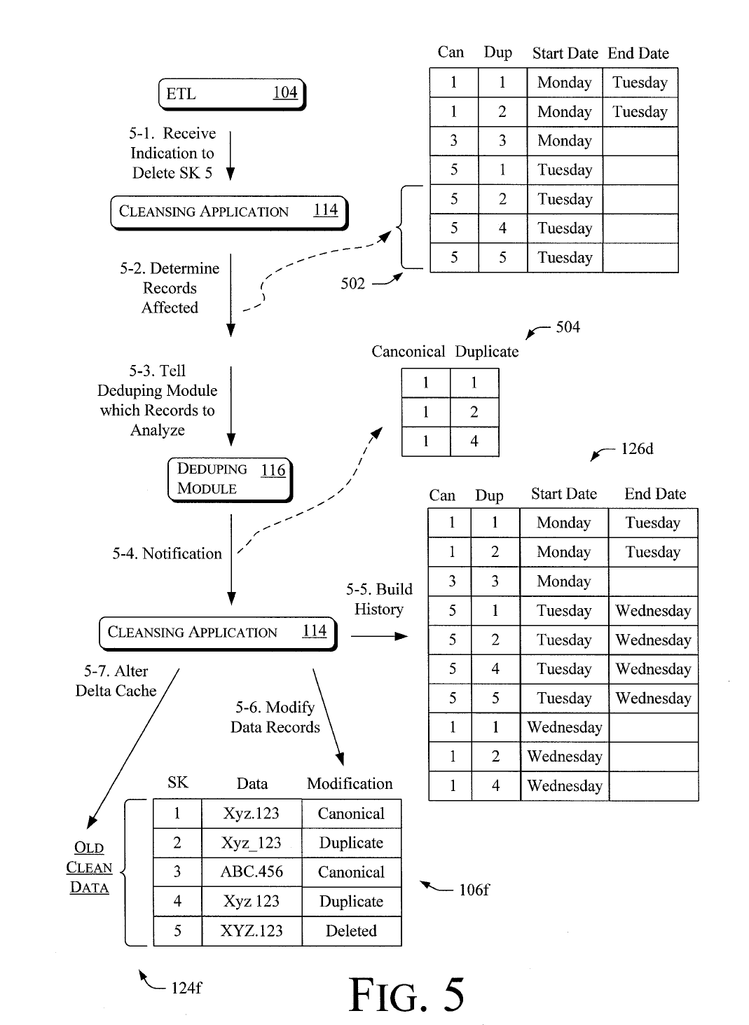

Assume, however, that a new incremental data loading indicates that a data record in the data warehouse has been altered in the source database. FIG. 5, for example, continues the prior illustration assuming that on Wednesday the ETL entity indicates at arrow 5-1 that record 5 has been deleted from the source database. This alteration to the data warehouse causes a problem—the canonical record for records 1, 2, and 4 is now deleted.

The cleansing application, however, has sufficient information in the history to address this problem without requiring that all of the records (1-5) be analyzed by the deduping module. Instead, the cleansing application at arrow 5-2 determines which records may be affected by this deletion—here records 1, 2, and 4, which are illustrated at 502, because they are in the history as duplicates of record 5.

After this determination, at arrow 5-3, the cleansing application tells the deduping module to find errors in records 1, 2, and 4. In response at arrow 5-4, the deduping module notifies the cleansing application that record 1 is a canonical record and records 2 and 4 are duplicates of 1, which is illustrated at 504.

Note that the cleansing application again enables the deduping module to analyze fewer than all of the records while permitting an equivalent result as if the deduping module analyzed all of the records.

Following this, and similarly to the manner described in FIGS. 2, 3, and 4, the cleansing application builds history 126d at arrow 5-5, automatically modifies the data records at arrow 5-6 the results of which are illustrated at 106f, and alters the delta cache at arrows 5-7 the results of which are illustrated at 124f. Note that history 126d indicates that record 1 is the canonical record for records 2 and 4 as of Wednesday. Note also that all of the records 1-4 are old clean data; all of them are clean amongst themselves and without the deduping module having to analyze record 3 against records 1, 2, and 4.

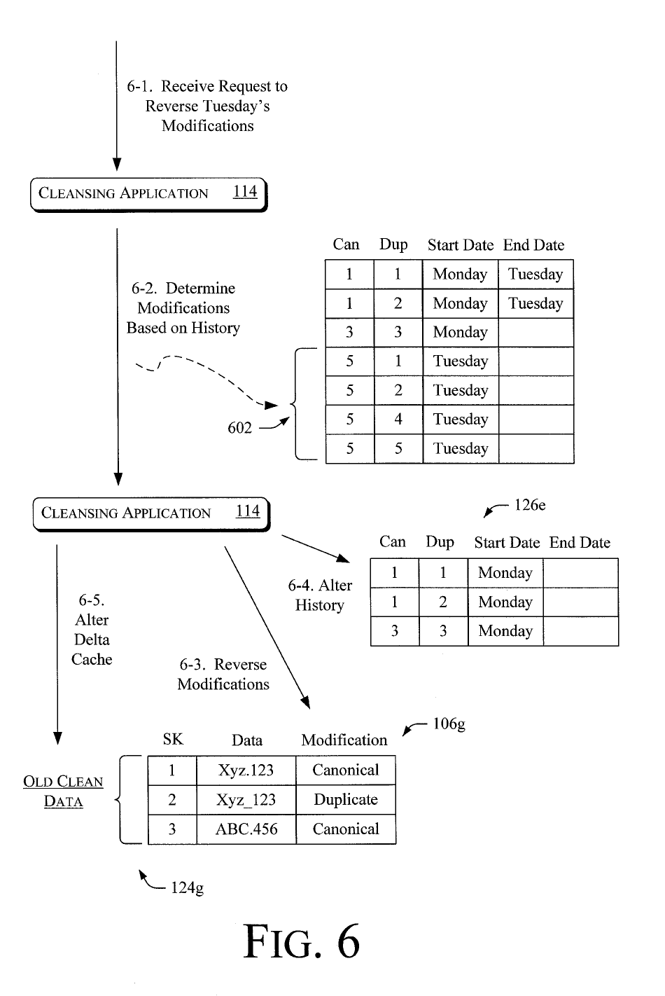

Alternatively, assume that on Wednesday and prior to the actions of FIG. 5 a data warehouse administrator discovers a problem and wants to reverse the changes made on Tuesday. To do so, he may simply request that the cleansing application reverse the changes (arrow 6-1 of FIG. 6). Continuing the ongoing example from FIG. 4, in FIG. 6 the cleansing application determines which actions were made to the data warehouse on Tuesday at arrow 6-2, which is illustrated at 602.

Responsive to determining the modifications made on Tuesday, the cleansing application automatically reverses the changes, thereby removing records 4 and 5 from the Old Clean Data shown in FIG. 4 after arrow 4-14. Here the cleansing application does so with a command to the data warehouse to remove the modification of arrow 4-14, resulting in the records as modified following arrow 3-8. After this reversal, the cleansing application commands the data warehouse to remove the modification of arrow 3-8, namely marking records 4 and 5 as duplicate and canonical, respectively. At this point the data warehouse is in the state it was in on Monday after arrow 3-2, namely with the data warehouse having five records with records 4 and 5 being New Dirty Data. If the delta cache is stored in the data warehouse, the cleansing application may also remove it. And, if the data warehouse administrator requests that the data warehouse be returned to its state on Monday before records 4 and 5 were loaded, the cleansing application may command the data warehouse to remove the records, thereby returning the data warehouse to its state immediately following arrows 2-7, 2-8, and 2-9 of FIG. 2, the results of which are illustrated at 126e for the history, 106g for the data records, and 124g for the delta cache

### Other Embodiments of the Tools

The above section describes one particular example where cleansing application 114 acts in conjunction with deduping data-quality module 116. In this section, other embodiments of the tools are described, such as modifying data records without human interaction to correct data errors in the records, modifying data records responsive to analysis from various types of data-quality modules, and/or reversing modifications.

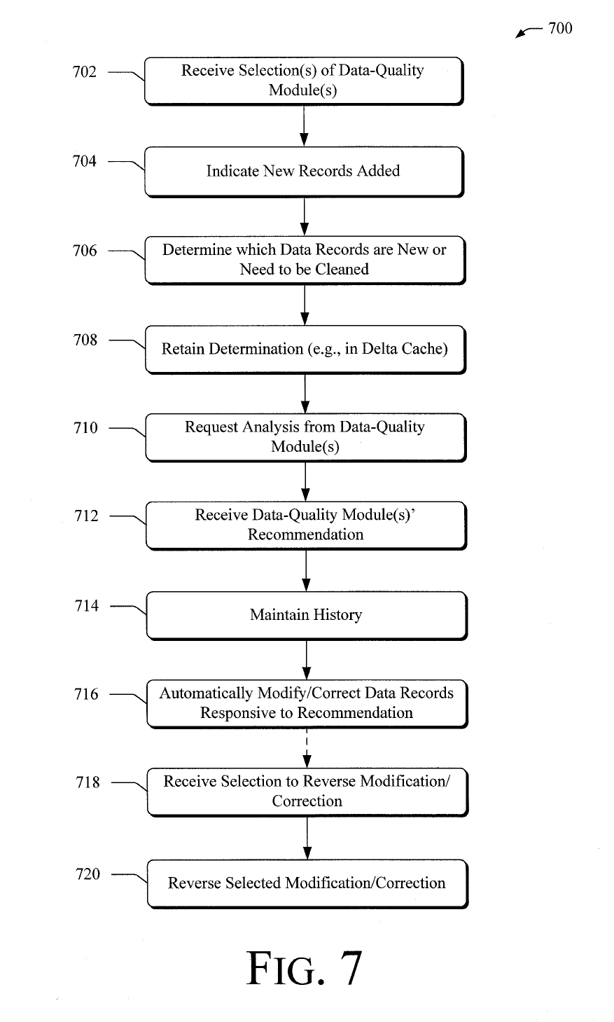

These exemplary embodiments are described as part of process 700 of FIG. 7. This process and the exemplary processes described or illustrated in FIGS. 2 through 6 may be implemented in any suitable hardware, software, firmware, or combination thereof; in the case of software and firmware, these processes represent sets of operations implemented as computer-executable instructions stored in computer-readable media and executable by one or more processors. These embodiments of the tools described in this section are not intended to limit the scope of the tools or the claims.

Block 702 receives a selection from a user or computing entity of one or more data-quality modules, such as deduping data-quality module 116, lookup data-quality module 118, standardization data-quality module 120, and structure extraction data-quality module 122 of FIG. 1. A user may select, for example, to select a standardization data-quality module for data records needing standard formats. Or a user may select a deduping data-quality module to find duplicate records. Or a user or computing entity may select more than one module, such as for data records known or found to need various types of cleaning. In some embodiments the tools enable a plug-and-play experience such that a user may simply select many types and brands of data-quality modules without any customization or complex interaction between the user and the tools. The cleansing application of FIG. 1, for example, may be capable of communicating records to analyze and receive recommendation of errors in formats acceptable to many types and brands of data-quality modules.

Block 704 indicates that new data records are added or will be added to a data warehouse. Block 704 may act to indicate that new records are being added as part of, or prior to, a process for loading data records into a data warehouse. As described above, for example, the tools may mark each data record with a unique, ascending surrogate key. This surrogate key identifies each record and, because of its ascending order, may be used to determine which record was added and when. Adding a surrogate key as part of an executable ETL package may require very little processing and add an insignificant amount of time to the ETL process.

Block 706 determines which data records in a data warehouse are new and/or need to be cleaned, either internally or relative to another set of data records in the data warehouse. As described in FIG. 2, for example, the cleansing application determines which data records are new based on receiving an indication of which were just added to a data warehouse, when, and what unique identifier was given each (e.g., each record's surrogate key).

Block 708 retains this determination for later use, such as in delta cache 124 of FIG. 1. In the example of FIGS. 2-6, the delta cache is a notation in the data warehouse indicating which records are dirty or clean and relative to which other records. One set of records, such as those newly received from an incremental ETL process, may be dirty relative to the other, newly received records, clean relative to just the newly received records, or clean relative to all records in the data warehouse. In some of the examples above, for example, a new set of data records is at first dirty, then clean to itself, and then clean the other sets.

Block 710 requests that the selected data-quality module or modules analyze some set of records, such as for data errors. Block 710 may request that a data-quality module find and notify the cleansing application of errors in a new set of data records that are dirty, such as the New Dirty Data of data records marked with SKs of 4 and 5 in FIG. 3.

Block 710 may request this analysis based on the delta cache, such as by indicating which records as noted in the delta cache are new and/or dirty (e.g., telling a data-quality module about records with SKs of 4 and 5 of FIG. 3).

In some cases, the data records may be clean internally but dirty relative another set of records (e.g., are New Clean Data that are not clean relative to Old Clean Data as illustrated in FIG. 3 following arrow 3-9). In these cases the tools enable a data-quality module to find errors or otherwise make cleansing recommendations by analyzing fewer than all of the records as well as if the data-quality module analyzed all of the records.

The tools may do so, in some cases, by indicating to the data-quality module which records are clean relative to which other records and not clean relative to others. Assume, as will often be the case, that one set of records is internally clean and large relative to the other set, such as data that over successive increments is growing large with each increment but has been made internally clean (e.g., such as if the actions of FIGS. 3 and 4 are repeated for many increments). Assume also that another set is also internally clean but is small, e.g., a small incremental set of data that has been cleaned amongst itself. The cleansing application may indicate this to a data-quality module in terms it understands, such as by indicating that the larger set is old and the smaller set is new. The data-quality module may then act, for example, to reduce the number of records needed to be analyzed based on this information. The data-quality module may sort all of the records of both sets and then analyze only the records of the new (or smaller set) based on windows around each of the smaller set's records in the sort, for example. As noted above, this may substantially reduce the processing needed by a data-quality module to find all errors or otherwise make recommendations.

Block 712 receives a recommendation from the selected data-quality module(s) indicating errors or giving non-error recommendations. The tools are capable of understanding these recommendations and acting on them. In some cases the recommendations are used to internally clean a set of data records (e.g., “New Dirty Records” of FIG. 2). These recommendations may also occur responsive to analyzing two sets of records that are clean relative to themselves but not relative to the other set. As noted above, for example, a new or small set of internally clean records may cause a data record in an older or larger set to be deemed as having an error by a data-quality module.

Block 714 maintains a history of the recommendations received, such as which records are duplicates and canonicals as described above. This history of recommendations may include all recommendations and actions made to records in the data warehouse. The history is sufficient to permit an audit of the data warehouse. It may also be sufficient to enable actions and modifications to the records in the data warehouse to be reversed, either manually (e.g., by human user entry) or automatically. As described in relation to FIG. 6, for example, the history can be sufficient to enable the cleansing application to automatically reverse modifications as of a particular date or all modifications for all dates, and even reverse changes made to the data warehouse that were not made by the data-quality module (e.g., addition of records marked with SK 4 and 5). This history is accessible by the tools, such as by being integral with the cleansing application of FIG. 1, or may be separate, such as by being stored in the data warehouse with the data records.

Block 716 automatically corrects or otherwise modifies the data records based on the recommendation. Block 716 is not required to modify the data records automatically, but may do so to reduce or eliminate user interaction with the tools. The modifications made by the tools may be to the extension or base of a data record or both. Process 700 may end at various points, such as after this block 716. In some cases, however, a user or computing entity wants to reverse a modification. In these cases, the tools may proceed to block 718, shown with a dashed arrow from block 716 to 718.

Block 718 receives an indication or selection to reverse a modification made to a data record in the data warehouse. This indication or selection may be received from a user or computing entity.

Based on this selection, block 720 reverses the modification. If the selection is to reverse one action, the tools may do so. If the selection is to reverse everything done to the data records since a certain time, the tools may also do so. The tools may do so automatically without manual user entry. Thus, the tools may act to return a data warehouse to a prior form exactly and automatically.

The tools may perform any of blocks 702 to 720 repeatedly, such as for many incremental new data records being added to a data warehouse. If the increments are every hour incident to a periodic ETL process, for instance, the tools permit flexibility not currently permitted if data cleansing must be part of the ETL process. A user may select that the tools only clean new data during the evening or at some other time of lower processing usage. Or the tools may track processing resource usage and clean data (either just a new set or a new clean set against an old clean set) when processing resource usage permits. Or the tools may clean (via blocks 704, 706, 708, 710, 712, 714, and/or 716) each set of new data internally but wait to clean it against old clean data in the data warehouse.

### CONCLUSION

The above-described tools are capable of modifying data records without human interaction, modifying data records responsive to analysis from various types of data-quality modules, reversing modifications, and/or enabling a data-quality module to find errors by analyzing fewer than all of the records as effectively as the data-quality module is capable of finding errors by analyzing all of the records. By so doing, the tools may permit data cleansing with fewer data resources and reduced user interaction. Although the tools have been described in language specific to structural features and/or methodological acts, it is to be understood that the tools defined in the appended claims are not necessarily limited to the specific features or acts described. Rather, the specific features and acts are disclosed as exemplary forms of implementing the tools.

1. One or more computer-readable media having computer-readable instructions therein that, when executed by a computing device, cause the computing device to perform acts comprising:
requesting, from a data-quality module, analysis of records newly added to a data warehouse;
receiving, from the data-quality module, a recommendation indicating errors found in the records by the data-quality module; and
correcting the records in the data warehouse based on the recommendation and without user interaction.

2. The media of claim 1, wherein the acts of receiving and correcting are performed outside of an Extract, Transform, and Load (ETL) process.

3. The media of claim 1, further comprising receiving selection of the data-quality module from a set of two or more data-quality modules.

4. The media of claim 3, further comprising receiving selection of a second data-quality module from the set and wherein the act of requesting requests analysis of the records by the second data-quality module.

5. The media of claim 4, wherein the act of receiving receives a second recommendation indicating errors found in the records by the second data-quality module and wherein the act of correcting the records corrects the records responsive to receiving and based on the second recommendation from the second data-quality module.

6. The media of claim 3, wherein the set comprises two or more of a lookup data-quality module, a standardization data-quality module, a structure extraction data-quality module, and a deduping data-quality module.

7. The media of claim 1, further comprising maintaining a history of the act of correcting the records sufficient to enable an audit of modifications to the records caused by the act of correcting.

8. The media of claim 7, wherein the history comprises information sufficient to enable automatic reversal of the modifications made to the records caused by the act of correcting.

9. The media of claim 1, wherein the acts of requesting, receiving, and correcting are performed once for each of multiple new sets of records added to the data warehouse effective to enable incremental cleansing of the data warehouse.

10. A method implemented at least in part by a computing device comprising:
maintaining a history of modifications made to records in a data warehouse;
receiving a request to reverse the modifications made to the records; and
reversing the modifications made to the records based on the history, responsive to the act of receiving the request, and without requiring manual user entry to reverse the modifications.

11. The method of claim 10, wherein the request comprises a date and the act of reversing the modifications reverses all of the modifications indicated in the history as being made on or after the date but not modifications made prior to the date.

12. The method of claim 10, wherein the history comprises a unique identifier for each of the records and dates that each of the modifications to each of the records was made.

13. The method of claim 10, wherein the history is stored in the data warehouse along with the records.

14. One or more computer-readable media comprising an application platform having computer-readable instructions therein that, when executed by a computing device, cause the computing device to perform acts comprising:
enabling a user to plug-and-play two or more of a set of data-cleansing modules capable of finding errors in data records, the set of data-cleansing modules comprising two or more of: a lookup data-cleansing module; a standardization data-cleansing module; a structure extraction data-cleansing module; and a deduping data-cleansing module; and
responsive to receiving selection from a user to plug-and-play two or more selected data-cleansing modules, modifying data records using the selected data-cleansing modules.

15. The platform of claim 14, wherein the instructions her cause the computing device to perform acts comprising maintaining a history providing information sufficient to enable a user to manually reverse a modification made to one of the data records by the platform.

16. The platform of claim 14, wherein the instructions further cause the computing device to perform acts comprising maintaining a history providing information sufficient to enable the platform to automatically reverse a modification previously made by the platform to one of the data records in the data warehouse.

17. The platform of claim 14, wherein the instructions further cause the computing device to perform acts comprising:
indicating to the selected data-quality modules data records newly added to a data warehouse to be analyzed for errors; and
receiving, from the selected data-quality modules, notification of errors found in the data records by the selected data-quality modules,
wherein the act of modifying is responsive to the act of receiving and is performed without user interaction.

18. The platform of claim 14, wherein the act of modifying data records is performed outside of an Extract, Transform, and Load (ETL) process.

19. The platform of claim 14, wherein the act of modifying data records is performed incrementally and automatically on each new set of data records added to a data warehouse.

20. The platform of claim 14, wherein the instructions further cause the computing device to perform acts comprising: indicating which data records in a data warehouse are new data records or old data records to the selected data-quality modules effective to enable the selected data-quality modules to find errors by analyzing fewer than all of the data records as effectively as the selected data-quality modules are capable of finding errors by analyzing all of the data records.
